(19) United States
(12) Patent Application Publication
(10) Pub. No.: US 2010/0161586 A1
(43) Pub. Date: Jun. 24, 2010

(54) SYSTEM AND METHOD OF MULTI-PAGE DISPLAY AND INTERACTION OF ANY INTERNET SEARCH ENGINE DATA ON AN INTERNET BROWSER

(76) Inventor: Samir H. Safar, San Diego, CA (US)

Correspondence Address: WHITE-WELKER & WELKER, LLC, P.O. BOX 199, CLEAR SPRING, MD, 21722-0199, US

(21) Appl. No.: 12/639,861

(22) Filed: Dec. 16, 2009

Related U.S. Application Data
(60) Provisional application No. 61/203,058, filed on Dec. 18, 2008.

(51) Int. Cl. G06F 17/30; G06F 3/048

(52) U.S. Cl. 707/707; 715/786; 707/E17.108; 707/706

(57) ABSTRACT

The present invention describes a system and method of displaying search engine results and comprises a method of Internet browser add-ons or a web-based program where the multi-page of the Internet search engine data is displayed partially on one window screen in multi-columns format, each column represents one search engine page of data. The invention is particularly, but not exclusively, useful as a system and methods with novel aspect to develop the Internet browser view more user friendly to the users and includes further a Download module to user computer and an Install/Remove module of the add-on software module.

### CROSS REFERENCE TO RELATED APPLICATIONS

This application claims priority from U.S. Provisional Patent Application Ser. No. 61/203,058, entitled “Internet Browser Multi-Webpage Display on One Screen Add-On Computer Software Module”, filed on 18 Dec. 2008. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention pertains to generally to systems and method of an Internet browser add-ons or program that can run on a server as a standalone program and not as an add-on to a browser so that a user does not have to download the program and can use any browser, where multi-pages of any Internet search engine data get partially displayed on one window screen in multi-column format. The invention is particularly, but not exclusively, useful as a system and methods to fortify development of Internet browser view.

### BACKGROUND OF THE INVENTION

The Internet is a valuable resource for providing users with information. In particular, consumers use the Internet to find information and make decisions among online entities such as websites, online merchants, online companies, or online services. Further, the Internet is evolving into a type of informational utility that helps the people to make important decisions and manage their day-to-day activities and needs. However, the amount of information available online is so large that it may be difficult to find relevant information.

Search engine display of information is a problem that people face every day when people search for particular information. Websites with optimization and advance payment to a search engine company make it difficult to get the desired results on the first page of search engine listing.

### SUMMARY OF THE INVENTION

The present invention describes a system and method of displaying search engine results and comprises a method of Internet browser add-ons where the multi-page of the Internet search engine data is displayed partially on one window screen in multi-columns format, each column represents one search engine page of data. The invention is particularly, but not exclusively, useful as a system and methods with novel aspect to develop the Internet browser view more user friendly to the users and includes further a Download module to user computer and an Install/Remove module of the add-on software module. A column configuration display of Internet search engine such GOOGLE, YAHOO, or MSN/BING that display multi-page on one window screen. The computer mouse drags the edge of each column to left or right of the window screen to increase or decreases the width of the columns. The present invention can display multi listing of any search engine pages on one browser window.

The main components of the present invention include an add-on software module to an Internet browser, that is download via a software module to a user's computer for execution, and includes an install/remove module of the add-on software module. The physical apparatus required to enable one embodiment of the present invention includes a web server; a web portal interface; a multi-user network; and an application server.

The program module is an add-on to a browser; a User can select 1, 2, 3, 4 or up to 5 columns to be displayed when searching a search engine. Each column represents one search engine page of data. It is downloaded from a server that on the Internet. It interfaces with MS EXPLORER, FIREFOX, SAFARI and GOOGLE CHROME. Users can condense or expand the column by clicking and dragging on the side border, left or right, to read more of the text of a specific column. Additionally, a user can use the top scroll of each column to view more of the page without expanding the columns. The top scroll was developed so a user does not have to scroll to the bottom of a column to engage a scroll feature every time.

Businesses invest huge amount of money to be listed on the top page of any search engine. Over 90% of Internet surfers never go beyond the second page in their search. Today, there is so little space on the first search engine page to satisfy this demand.

Therefore it is an objective of the present invention to teach a display multi listing of any search engine pages on one browser window.

It is another objective of the present invention to teach businesses and website owners will invest less money to be listed on top page.

It is yet another objective of the present invention to teach a method for less spending on search engine optimization (SEO).

It is still another objective of the present invention to teach a system and method where a user can see thirty or more search engine listing at one time.

Therefore what is needed is an Internet search engine display of information, that will not only solve the major problems previously discussed, but will reduce the cost of paying for search engine optimization (SEO).

Businesses also pay search engine companies to advertise on the top of the page or the side of the page. The present invention eliminates most of the paid advertisements from being displayed at the top, bottom, or side of each search page, which makes the displayed search results simpler and cleaner for the user.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 is a screen shot that illustrates the components of this module add-on which include a Main Internet browser screen, the Internet search engine, and a plurality of columns of pages: one, two and three of Internet search engine with column boundaries;

FIG. 2 is a flow chart illustrating the process of searching multiple keywords for the same engine a the same time; and

FIG. 3 is a flow chart illustrating the Vertical and Top Scrollbars Logic;

FIG. 4 is a screen shot that illustrates a five-column embodiment of the present invention;

FIG. 5 is a screen shot that illustrates a three-column embodiment of the present invention using a multiple keyword search for each respective column;

FIGS. 6a and 6b are screen shots that illustrate the two URL link openings taught by the present invention where selecting a URL link may open a new browser page or sleeking a URL link may open the selected link page within the column; and

FIG. 7 is a screen shot of the three search engine embodiment of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The main components of the present invention include an add-on software module to an Internet browser, that is download via a software module to a user's computer for execution, and includes an install/remove module of the add-on software module. The program runs as a web-based site without using the add-on/extension of the browser. This makes the present invention a global Internet search tool. As a stand alone web-based site, a user does not have to download the program and can use any browser.

The physical apparatus required to enable one embodiment of the present invention includes a web server; a web portal interface; a multi-user network; and an application server. Thus, the method of the present invention may also be recorded onto a CD, or any other recordable medium as well as being delivered electronically from a database to a computer, wherein the method embodied by the software that is recorded is then executed by a computer for use and transformation of the Internet browser and its contents.

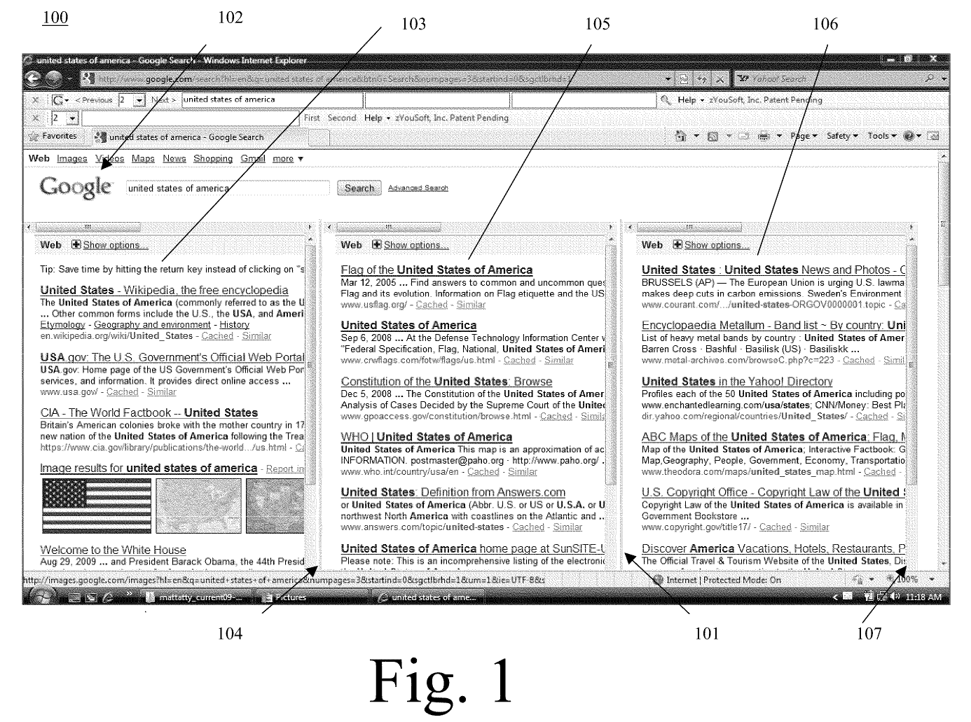

Now referring to the Figures, the embodiment of the system and method of multi-page display and interaction of any Internet search engine data on an Internet browser is shown. FIG. 1 illustrates the components of this module add-on. The components of the present invention shown in FIG. 1 are: a main Internet browser screen 100, an Internet search engine 102, a plurality of columns of pages 103, 105, and 106 corresponding to a respective Internet search engine, and column boundaries 101, 104, and 107.

As shown in FIG. 1, the present invention describes a system and method of displaying search engine results and comprises a method of Internet browser add-ons where the multi-page of the Internet search engine data is displayed partially on one window screen in a multi-column format, each column represents one search engine page of data. The invention is particularly, but not exclusively, useful as a system and methods with novel aspect to develop the Internet browser view more user friendly to the users and includes further a Download module to user computer and an Install/Remove module of the add-on software module.

FIG. 1 illustrates a column configuration display of an Internet search engine such GOOGLE, YAHOO, or MSN/BING that displays multi-pages on one window screen. By using a computer mouse one can drag the edge of each column 101, 104, or 107 to left or right of the window screen to increase or decreases the width of the columns. The present invention displays multi-listing of any search engine pages on one browser window 100.

The visual result of the present invention is the return of multiple pages of search results in a single page with the original look of the search result page. Results from multiple search engines are oriented side by side. This reorganized page offers better visibility of search results in the frame with a smaller size

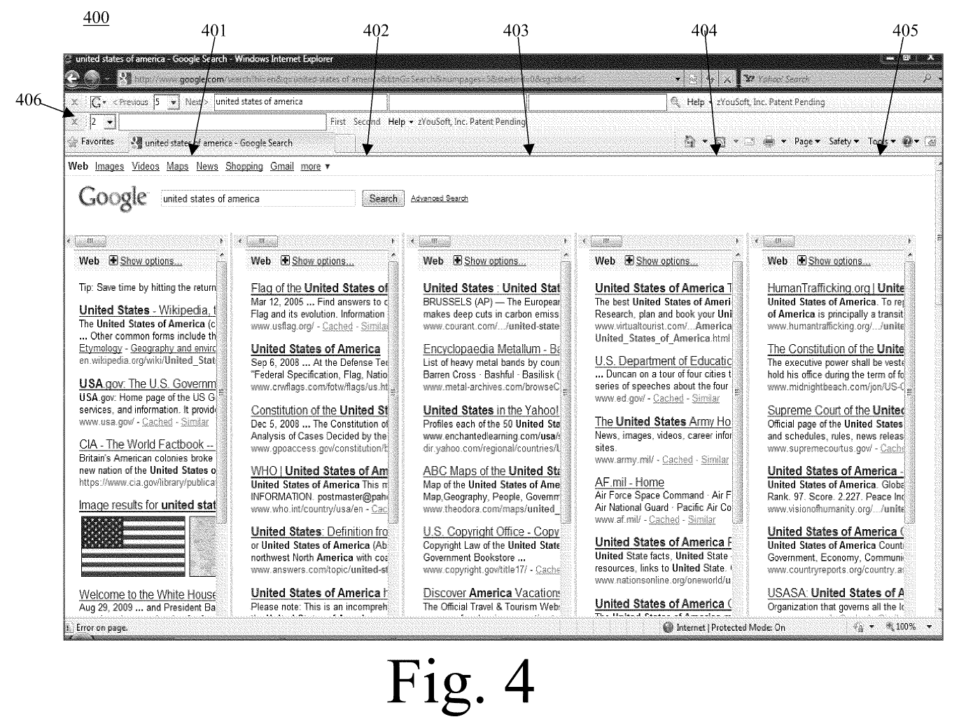

The program module is an add-on to a browser; a User can select up to five columns 401, 402, 403, 404, and 405 to be displayed when searching a search engine 406 as show in FIG. 4. Each column represents one search engine page of data. The search engine data is downloaded from a server that is located or found on the Internet. The present invention enables users to view up to five pages of any search engine at the same time using one browser window 400. Alternatively, the present invention also enables users to search five pages at the same time of any engine if desired.

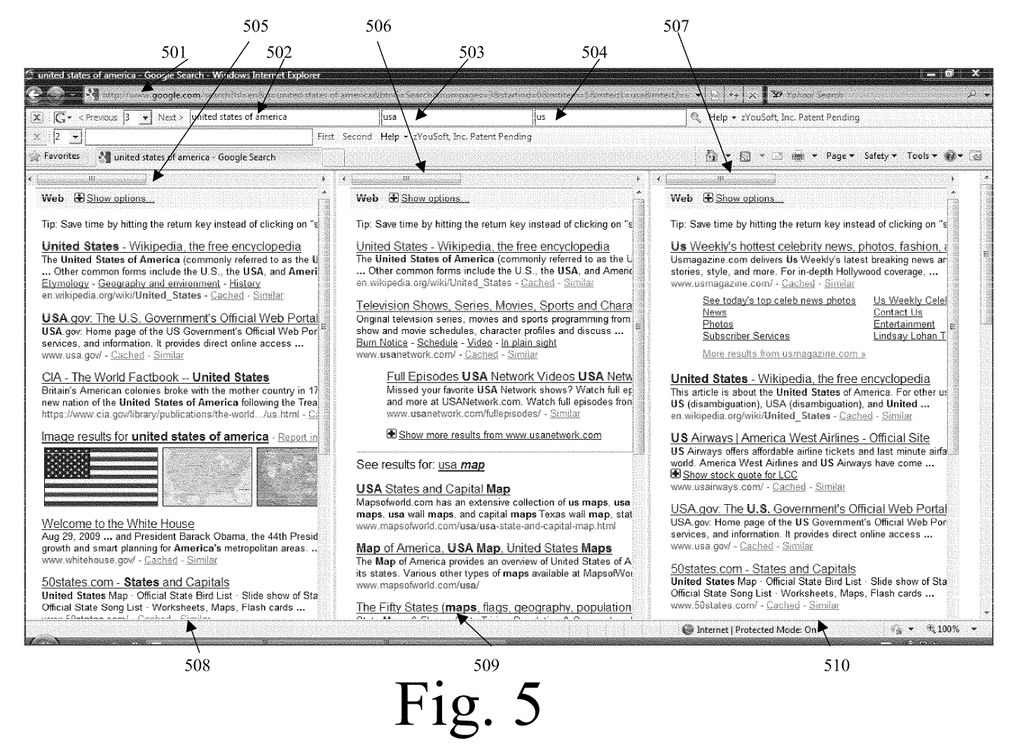

The present invention enables users to search multiple keywords words of any search engine at the same time using one browser window only to display and compare the results as shown in FIG. 5. The present invention displays each corresponding keyword in a separate column. A first keyword 502 will be displayed in a first column 509, a second keyword 503 will be displayed in a second column 510, and a third keyword 504 will be display in a third column 511. If user enters a keywords in the second keyword location 503 or the third keyword location 504, the program automatically changes the dropdown menu number to 3. The present invention enables users to search and view multiple search engines at the same time using one browser window only.

The present invention enables users to view multiple websites at the same time using only one browser window. The program is unique by having a top horizontal scroll bar 505, 506, 507 for each frame/column. With this, the present invention has infinite page size or column size.

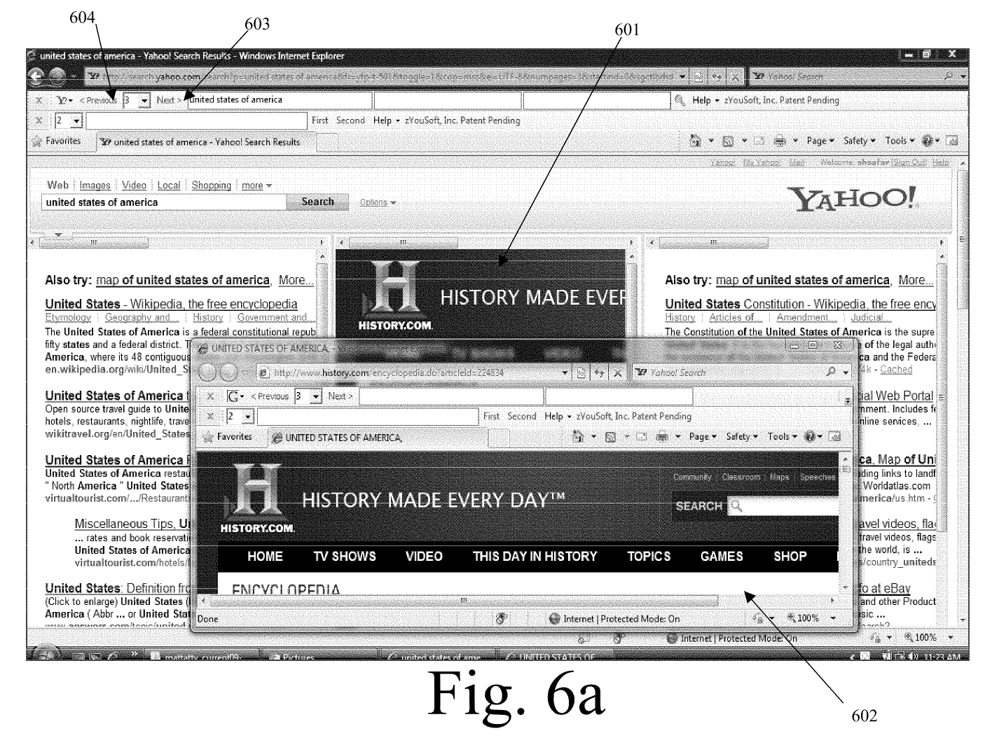

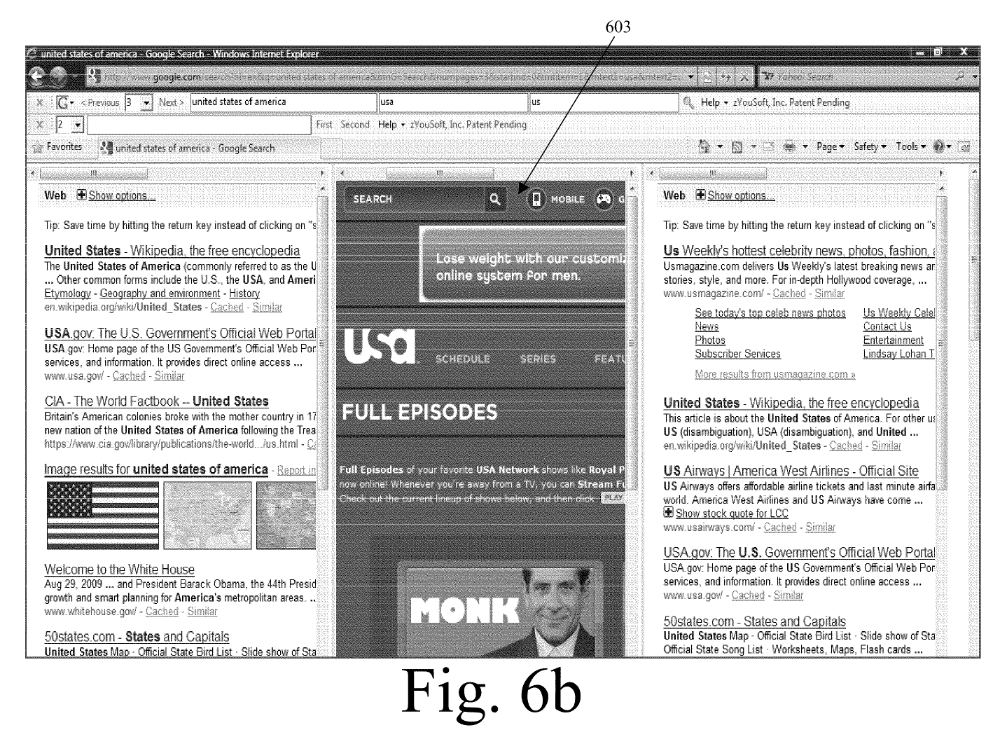

Now referring to FIGS. 6a and 6b, by double clicking on any search engine link 601, the user can open that link 601 in a new window 602 for future review. In the alternative, by double clicking on a search engine link 601, the user can open the link 601 in the column/frame 604 for immediate review.

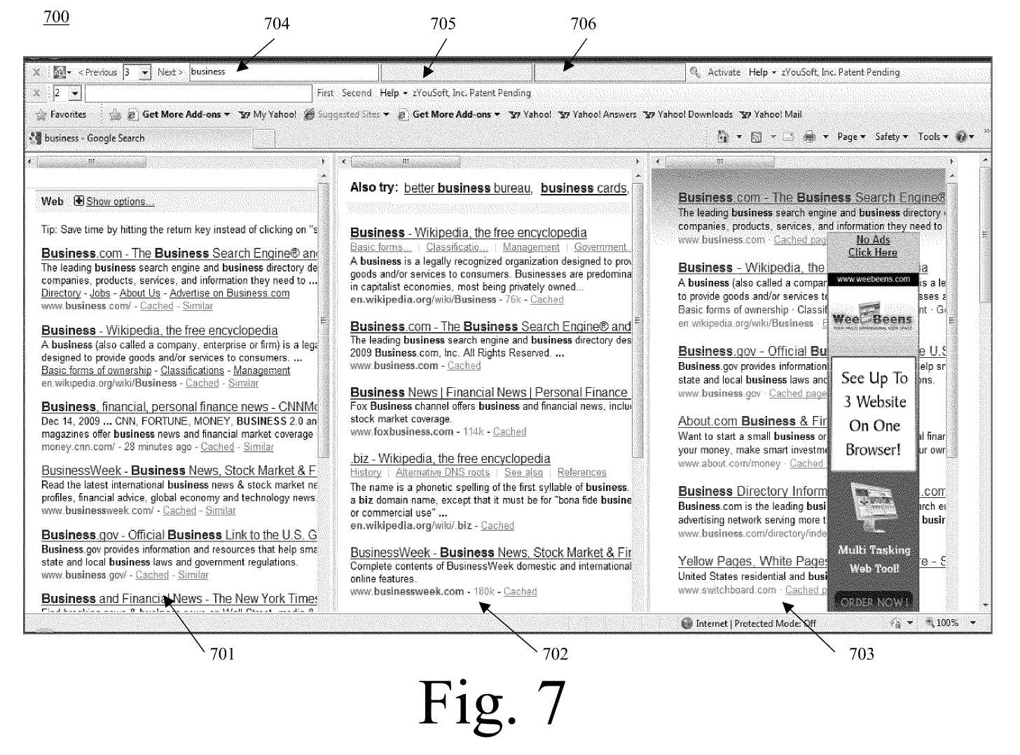

Now referring to FIG. 7, the present invention enables users to search multiple keywords words 704, 705, and 706 of multiple search engines 701, 702, and 703 at the same time using one browser window 700 only to display and compare the results as shown in FIG. 7. The present invention displays each corresponding keyword search results in a separate column for each search engine, 701, 702, and 703. A first keyword 704 search engine result will be displayed in a first column 701, a second keyword 705 be displayed in a second column 702, and a third keyword 706 will be display in a third column 703. The present invention enables users to search and view multiple search engine results at the same time using one browser window 700 only.

In other alternatives and methods that are developing, to open a website in a new window may be accomplished by the addition of an icon at the top of each column 508, 509, and 510 with the functionality to open a new window when clicked. This will make the present invention more user friendly.

The present invention also shows each search result as a live proxy. The program web-based program has an advertising module that integrates with the search results as well.

The present invention also rewrites relative links in the search result page to full URL, so that the user may click on any link and get the desired page. Additionally, the individual search results appear as the original search result page in each frame or column of the intended application page, though cross frame scripting is possible. Search results are not cached, which enables search of the fly.

Next buttons 603 and previous buttons 604 will show the next and previous pages of the search result, this enables a user to have a glimpse of the entire search result easily.

The present invention also includes server side search result page parsing and recreating in memory stub page for showing in the application page.

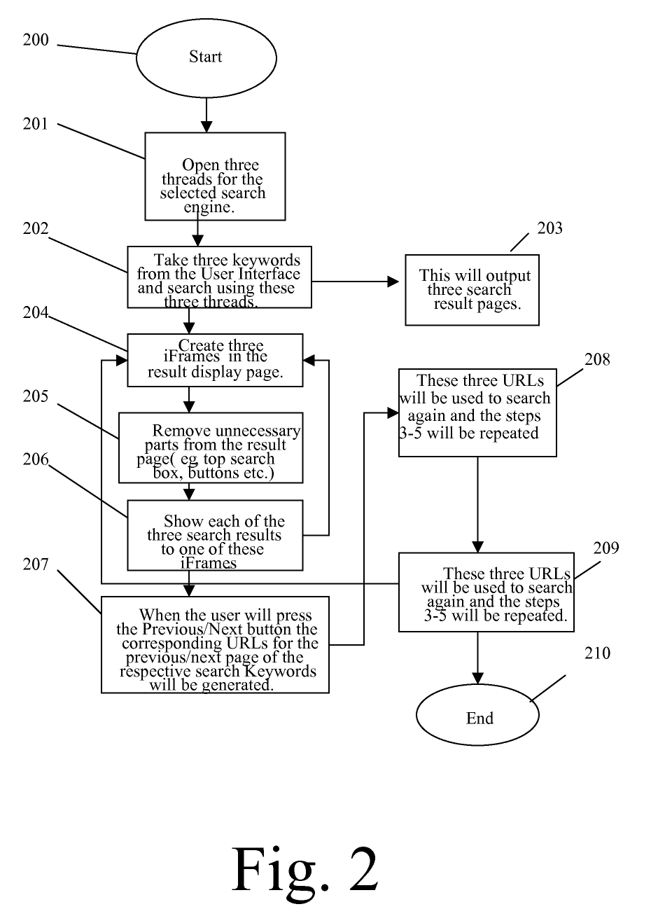

Now referring to FIG. 2, the method for searching multiple keywords for the same search engine at the same time is shown. A user starts 200 by opening three threads for the selected search engine 201. Next three keywords from the User Interface are taken and a search is conducted using these three threads 202 that results in an output of three search result pages 203. Three iFrames are created in the results display page 204. Unnecessary parts are removed form the results page 205 such as the tope search box and other buttons. Each of the three results to one of the iFrames is then shown 206 and this process is repeated for the number of iFrames created in step 204. When a user presses the previous/next button the corresponding URL for the previous/next page of the respective search Keywords is generated in step 207. The three URLs are then used to search again in step 208 and steps 204, 205, and 206 are repeated 209. When all searchers are complete, the process ends 210.

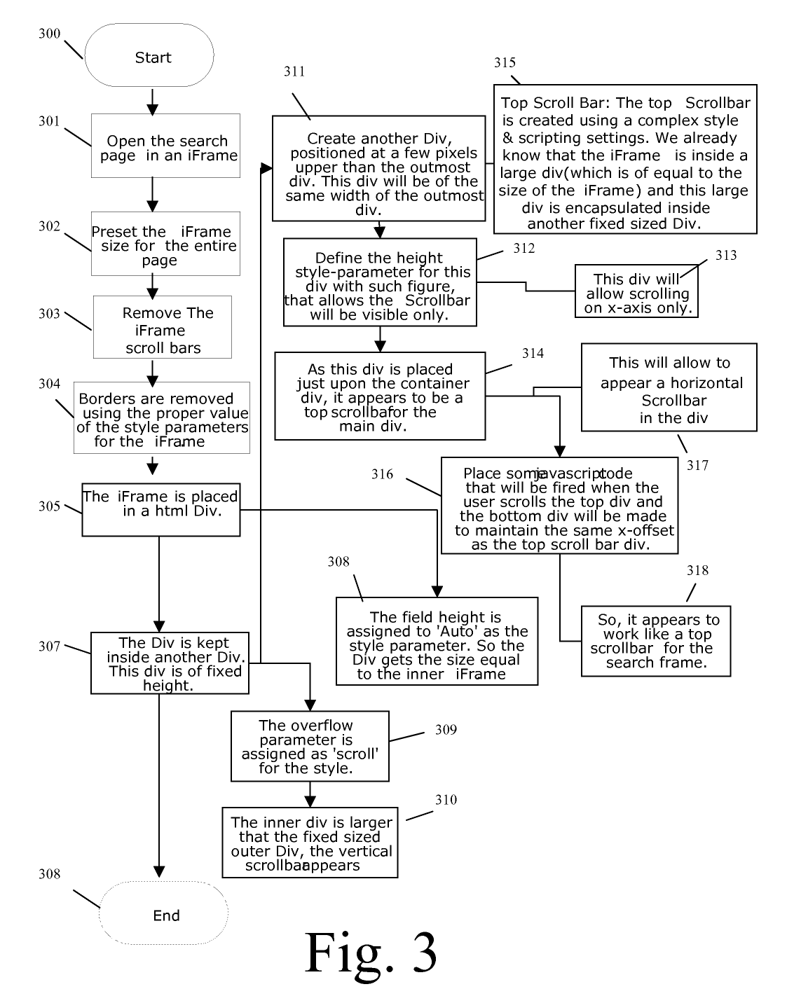

Now referring to FIG. 3, the vertical and top scrollbars logic is illustrated. The process starts 300 when the search page in an iFrame is opened 301. The iFrame size is then preset for the entire page 302 and the iFrame scroll bars are removed 303. Additionally, borders are removed using the proper value of the style parameters for the iFrame 304 and the iFrame is placed in an html Div. 305. The field height is assigned to “auto” as the style parameter so the Div. gets the size equal to the inner iFrame in step 206.

DIV tags are codes that define a section in an HTML (HyperText Markup Language) document. A section in HTML can also be described as a “division,” which is the origin of the abbreviation used for the name of the DIV tag.

DIV tags, like SPAN tags, do not apply meaning to content as is the case with most HTML For instance, “P” creates a paragraph, “B” creates boldface, and “H” creates a heading. DIV doesn't actually do anything at all by itself; it simply defines a block of content on the page to which other attributes can be globally applied. DIV tags indicate that a block of code belongs together.

In step 307 the Div. is kept inside another Div. Additionally, the overflow parameter is assigned as “scroll” for the style in step 309 and the inner Div. is larger than the fixed size of the outer Div., and the vertical scroll bar appears in step 310. This Div. is of fixed height and then the process either ends 308 or continues to created another Div. position at a few pixels upper than the outermost Div. in step 311 This Div. will be of the same width of the outermost Div. In step 315, the top scroll bar is created using a complex style and scripting settings. The iFrame is inside a large Div. which is of equal value to the size of the iFrame and this large Div is encapsulated inside another fixed size Div.

The height style parameter for the Div. created in step 311 is defined in step 312 that allows only the scroll bar to be visible and step 313 constrains this scroll bar to the x-axis only. The Div. crated in step 311 is then placed just upon the container Div in step 314 so that is appears to be a top scroll bar for the main Div. in step 315. In step 316, some javascript code that will be fired when the user scrolls the top Div. and the bottom Div. will be made to maintain the same x-offset as the top scroll bar Div. In step 317, this allows a horizontal scroll bar to appear in the Div. as created in step 301, which then appears to work as a top scroll bar for the search frame in step 318.

This module is not limited to text search only, it could be used or adapted by one of ordinary skill in the art for used with image searching.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A computer-implemented method of multi-page display and interaction of any search engine data on a browser, the method comprising:
downloading a software module to a user's computer for execution,
running a browser on a user's computer;
opening a browser window;
running the software module as a web-based site;
accessing a search engine;
initiating a search on the search engine via the browser;
returning search engine results;
creating a plurality of columns of pages corresponding to the search engine's results,
creating column boundaries dividing the search engine results;
orienting the search results side by side for multiple search engines;
displaying the search results as the original search result page in each frame of the intended application page; and
displaying search engine result wherein multi-pages of the search engine results are displayed partially on one window screen in multi-columns format using the created columns.

2. The computer-implemented method of multi-page display and interaction of any search engine data on a browser of claim 1 further comprising the steps of:
rewriting relative links in the search result page to full URL; and
selecting any link loads in the page associated with that link.

3. The computer-implemented method of multi-page display and interaction of any search engine data on a browser of claim 1 further comprising the step of:
representing in each column, one search engine page of data, and
downloading the search engine data from a server that is located or found on the Internet.

4. The computer-implemented method of multi-page display and interaction of any search engine data on a browser of claim 1 further comprising the step of:
displaying the multi-listing of any search engine's pages on one browser window.

5. The computer-implemented method of multi-page display and interaction of any search engine data on a browser of claim 1 wherein the program module is an add-on to the browser.

6. The computer-implemented method of multi-page display and interaction of any search engine data on a browser of claim 1 further comprising the step of:
selecting a plurality of columns to be displayed when searching a search engine.

7. The computer-implemented method of multi-page display and interaction of any search engine data on a browser of claim 1 further comprising the step of:
selecting one, two, three, four, or five columns to be displayed when searching a search engine.

8. The computer-implemented method of multi-page display and interaction of any search engine data on a browser of claim 1 wherein each column represents one search engine page of data.

9. The computer-implemented method of multi-page display and interaction of any search engine data on a browser of claim 1 further comprising the step of:
downloading the software module from a server on the Internet.

10. The computer-implemented method of multi-page display and interaction of any search engine data on a browser of claim 1 wherein each column is defined as having a top border, a bottom border, a left border, and a right border.

11. The computer-implemented method of multi-page display and interaction of any search engine data on a browser of claim 10 further comprising the step of:
using a computer mouse to drag the edge of each column border to the left or right of the window screen to increase or decreases the width of the columns.

12. The computer-implemented method of multi-page display and interaction of any search engine data on a browser of claim 10 further comprising the step of:
condensing or expanding the columns by clicking and dragging on the side border, left or right, to read more of the text of a specific column.

13. The computer-implemented method of multi-page display and interaction of any search engine data on a browser of claim 1 further comprising the step of:
enabling the viewing of up to five pages of any search engine at the same time using one browser window.

14. The computer-implemented method of multi-page display and interaction of any search engine data on a browser of claim 13 further comprising the step of:
searching five pages of search results at the same time of any one search engine.

15. The computer-implemented method of multi-page display and interaction of any search engine data on a browser of claim 13 further comprising the step of:
searching a single page of search results from one search engine at the same time for three search engines.

16. The computer-implemented method of multi-page display and interaction of any search engine data on a browser of claim 1 further comprising the step of:
searching and viewing multiple search engines at the same time using only one browser window.

17. The computer-implemented method of multi-page display and interaction of any search engine data on a browser of claim 1 further comprising the step of:
searching multiple keywords words of any search engine at the same time using one browser window only to display and compare the results.

18. The computer-implemented method of multi-page display and interaction of any search engine data on a browser of claim 1 further comprising the step of:
displaying next and previous buttons the will show the next pages of the search result,
providing a top horizontal scroll bar for each column, and
double clicking on any search engine link opens that link in a new window.

19. The computer-implemented method of multi-page display and interaction of any search engine data on a browser of claim 1 further comprising the step of:
showing each search result as a live proxy.

20. The computer-implemented method of multi-page display and interaction of any search engine data on a browser of claim 1 further comprising the step of:
integrating an advertising module with the search results; and
including a server side search result page parsing and recreating an in memory stub page for display in an application page.

21. The computer-implemented method of multi-page display and interaction of any search engine data on a browser of claim 18 further comprising the step of:
adding an icon for each column;
associated a link or page with the icon; and
selecting or clicking the icon opens a new page associated with the icon page in a new browser window.

22. The computer-implemented method of multi-page display and interaction of any search engine data on a browser of claim 1 further comprising the step of:
providing a horizontal scroll bar for each column;
displaying the horizontal scroll bar horizontally within the column between the column boundaries dividing the search engine results; and
orienting the horizontal scroll bar at the top position in each frame of the column.
